(19) United States
(12) Patent Application Publication
(10) Pub. No.: US 2019/0208742 A1
(43) Pub. Date: Jul. 11, 2019

(54) SPACER TEXTILE-BASED THERAPEUTIC SUPPORT PAD FOR CANINES AND METHODS OF USE THEREOF

(71) Applicant: HipSaver, Inc., Norwood, MA (US)

(72) Inventors: Edward L. GOODWIN, Canton, MA (US); Eric C. ZIMMERMAN, Abington, MA (US)

(21) Appl. No.: 16/354,614

(22) Filed: Mar. 15, 2019

Related U.S. Application Data
(60) Provisional application No. 62/816,592, filed on Mar. 11, 2019.

(51) Int. Cl. A01K 1/035; A47C 27/22

(52) U.S. Cl. CPC A01K 1/0353; A47C 27/12; A47C 27/22

(57) ABSTRACT

Methods of maintaining or restoring joint function in a canine in need thereof by allowing the canine to lie on a pad are provided. The pad includes one or more layers of a spacer textile, where the spacer textile includes a top surface, a bottom surface, and a plurality of spacer fibers therebetween. The one or more layers of a spacer textile, when in contact with a joint of a canine, provides an upward force attenuation onto the joint.

### BACKGROUND

Nutrition, hydration, and moderate exercise all play a role in hip joint health. For a modern-day canine, hind quarter weight, joint, e.g., hip or shoulder joint, anatomy, and sleep position play a major role in joint weakness. Sleeping on hard surfaces contrasts with ancient “dogs in the wild” who slept on softer grass or dirt. Also, canines sleep mostly on their side, putting weight on the hip bone. This pressure, combined with canine hip anatomy creates, large pressure forces on the hip lubricating sac called the “articular cartilage.” The lubricating cartilage sac is partially dehydrated during every sleep period, and can weaken the hip joint over time (Edwards, Inst. Mech. Engrs., Proc 181:16-24, 1967). The canine's hind quarter weight sets up a bone conductive force axis from the articular cartilage to the external skin; thus, the force on the cartilage is the same as the force on the external skin.

Currently, “memory foam” (e.g., polyurethane) pads are available as therapeutic canine sleeping pads. Generally, memory foam pads have an indentation resistance of about 10, measured by the Shore durometer OO scale (an industry standard metric for the amount of indentation resistance), which represents a low indentation resistance.

One drawback from having a low indentation resistance, e.g., a low Shore durometer 00 value, is the requirement of a thick pad. A heavier object is likely to create a large indentation when placed on the pad, compressing the pad completely and thus providing little reduction of upward force. As canines typically sleep on their hips, e.g., side-lying, a constant upward force is exerted on the hip, resulting in sore, dehydrated hip joints. Furthermore, memory foam provides an unstable footing for a canine as it attempts to stand. The low indentation resistance of the memory foam provides little support to the paws of the canine as they sink into the memory foam. This instability is compounded by the discomfort from the partially dehydrated lubricating sack of the hip joint. Thus, memory foam orthopedic pads, because of their low Shore durometer OO values, do not adequately reduce bone conductive hip pressure and provide for an unstable, e.g., shaky, standing surface when a canine attempts to stand and leave the pad. These factors can result in a decreased motivation to stand, especially in geriatric or infirm canines, which can result in further hip dysfunction.

Therefore, pressure relieving surfaces that limit the force exerted on a joint and do not present a challenge to standing would be valuable in the prevention and restoration of joint function in a canine.

### SUMMARY OF THE INVENTION

In an aspect, the invention features a method of maintaining or restoring joint function in a canine in need thereof. The method includes providing a pad including one or more layers of a spacer textile, where each of the one or more layers of the spacer textile has a top surface, a bottom surface, and plurality of spacer fibers therebetween; and allowing the canine to contact a joint on the top surface of the pad, where the one or more layers of the spacer textile of the pad provides an upward force attenuation onto the joint.

In some embodiments, each of the one or more layers may have a thickness from 2 to 16 mm, e.g., from 2 mm to 7 mm, from 3 mm to 8 mm, from 4 mm to 9 mm, from 10 mm to 15 mm, or from 11 mm to 16 mm, e.g., 2 mm, 3 mm, 4 mm, 5 mm, 6 mm, mm 7, 8 mm, 9 mm, 10 mm, 11 mm, 12 mm, 13 mm, 14 mm, 15 mm, or 16 mm.

In certain embodiments, the spacer textile may have a thickness from 3 to 30 mm, e.g., from 3 mm to 10 mm, from 5 mm to 15, from 10 mm to 20 mm, from 15 mm to 25 mm, or from 20 mm to 30 mm, e.g., 3 mm, 4 mm, 5 mm, 6 mm, mm 7, 8 mm, 9 mm, 10 mm, 11 mm, 12 mm, 13 mm, 14 mm, 15 mm, or 16 mm, 17 mm, 18 mm, 19 mm, 20 mm, 21 mm, 22 mm, 23 mm, 24 mm, 25 mm, 26 mm, 27 mm, 28 mm, 29 mm, or 30 mm.

An exemplary pad has a thickness of 12 mm and has five layers of a spacer textile.

In some embodiments of the invention, the pad registers an indentation load resistance from 15 to 50, e.g., from 15 to 30, from 20 to 35, from 25 to 40, or from 35 to 50, as measured by the Shore durometer scale OO.

In certain embodiments, the top surface or bottom surface of each of the one or more layers of the spacer textile are a material selected from the group consisting of polyester, elastane, rayon, acrylic copolymers, nylon, polypropylene, cotton, tricot, olefin, or a combination thereof. In particular embodiments, the top surface or bottom surface of each of the one or more layers of the spacer textile is a combination of polyester and elastane copolymer.

In some embodiments, the spacer fibers are a material selected from the group consisting of polyester or a semi-rigid polymer. In particular embodiments, the spacer fibers may be polyester. In some embodiments, the plurality of spacer fibers of each of the one or more layers are oriented substantially in the same direction. In another embodiment, the plurality of spacer fibers in each of the one or more layers are oriented in a staggered configuration.

In some embodiments, the top surface of the uppermost layer of the spacer textile further includes a comfort-enhancing material. In certain embodiments, the comfort-enhancing material is an expanded urethane (e.g., polyurethane, e.g., “memory foam” or similar), a polyfill, closed cell foam, or open cell foam. In another embodiment, the comfort-enhancing material includes faux fur. In certain embodiments, the bottom surface of the lowermost layer of the spacer textile further includes a slip-resistant material. In some embodiments, the slip-resistant material may be polyvinylchloride (PVC), urethane, copolymers, polymer coated fabrics, a thermoplastic polyolefin (TPO), natural rubber, or synthetic rubber.

### BRIEF DESCRIPTION OF THE DRAWINGS

FIG. 1 is a side view of a spacer textile.

FIG. 2 is a perspective view of a spacer textile subjected to a force normal to the face of the textile.

FIG. 3 shows a layered spacer textile according to an embodiment of the invention.

FIGS. 4A-4B are illustrations of a pad according to an embodiment of the invention with the hind quarters of a canine present on the top surface. FIG. 4A shows a pad made from a single layer of a spacer textile. FIG. 4B shows a pad made from five layers of a spacer textile.

FIG. 5 is an illustration of the decreased pressure exerted on a canine hip bone when lying on its side according to an embodiment of the invention.

### DETAILED DESCRIPTION OF THE INVENTION

The present invention provides a method of maintaining or restoring joint function in a canine in need thereof by allowing a canine to contact a joint on a pad. The pad includes one or more layers of a spacer textile that provides an upward force attenuation to the joint that is in contract with the pad, thereby maintaining or restoring joint function in a canine.

### Definitions

As used in this description and the accompanying claims, the following terms shall have the meanings indicated, unless the context otherwise requires:

A “semi-rigid polymer,” as used herein, is a polymer fiber having some degree of flexibility under an applied load while maintaining an overall uniform structure. Semi-rigid polymers resist flexural fatigue, e.g., compression set, and can rapidly return to their original structure once an applied load is removed.

A “spacer textile,” as used herein, includes any fabric comprising two textile substrates joined together by an array of filaments where the filaments are substantially perpendicular to the textile substrates.

The “orientation” of a spacer textile, as used herein, indicated a direction, parallel to the substrate, towards which a majority of the filaments bow, when the spacer textile is compressed by a load perpendicular to the substrate.

In the event of any term having an inconsistent definition between this application and a referenced document, the term is to be interpreted as defined herein.

### Pads Incorporating Spacer Textiles

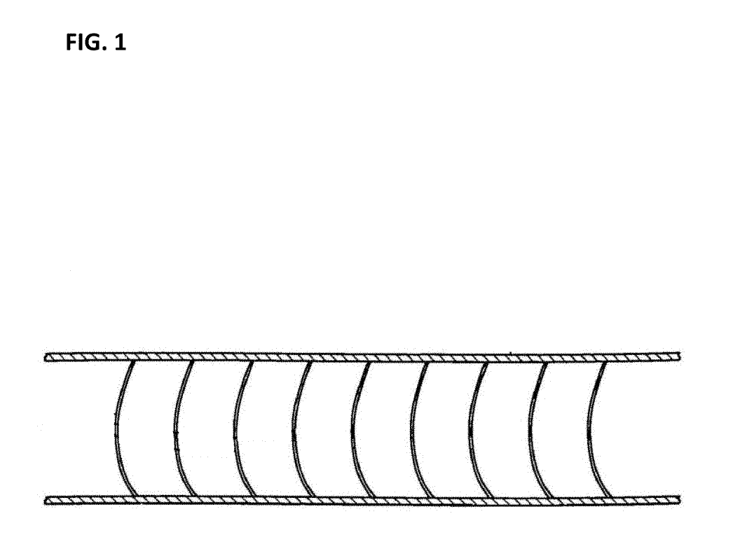

According to the invention, pads having one or more layers of a spacer textile offer relief from pressure on a joint, e.g., hip or shoulder, of a canine while it lies down. As shown in FIG. 1, a spacer textile consists of two fabric substrates, which define a top surface and a bottom surface, respectively, connected by a plurality of spacer fibers therebetween, which may be monofilaments. In some embodiments, the top surface or bottom surface of each of the one or more layers of the spacer textile comprises a material selected from the group consisting of polyester, elastane, rayon, acrylic copolymers, nylon, polypropylene, cotton, tricot, olefin, or a combination thereof. An exemplary top or bottom surface material is the combination of polyester and elastane copolymer.

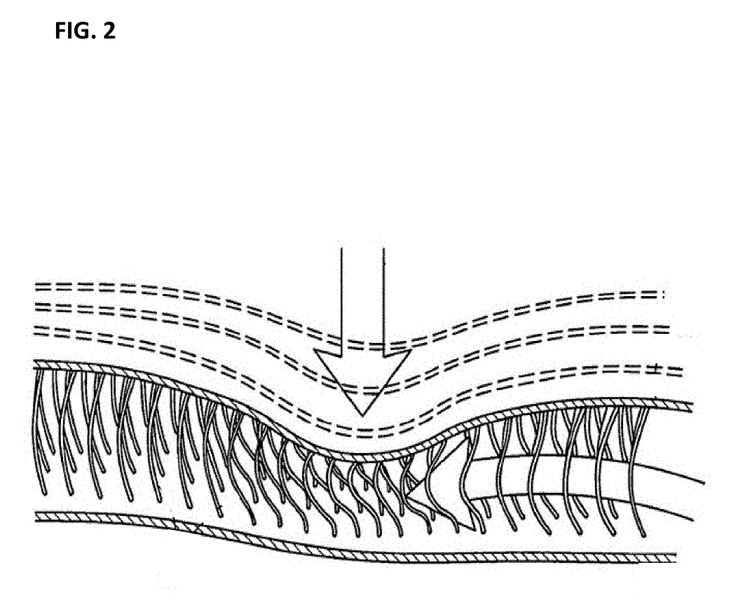

The plurality of spacer fibers are connected substantially perpendicular to the two fabric substrates. When subjected to a force, shown as the downward pointing arrow in FIG. 2, these spacer textiles are resilient due to the connecting spacer fibers that act like miniature springs. Thus, spacer textiles may be used for pressure relief and to mitigate shear forces and friction applied to the spacer textile surface. Note in FIG. 2 the uniformly oriented, slightly bowed structure of the spacer fibers connecting the top and bottom surfaces, which is typical of spacer textiles. The structure results in a tendency to deflect unevenly when depressed, creating unbalanced pressure relieving forces. The orientation or bow of a spacer textile corresponds to the direction in which these spacer fibers deflect.

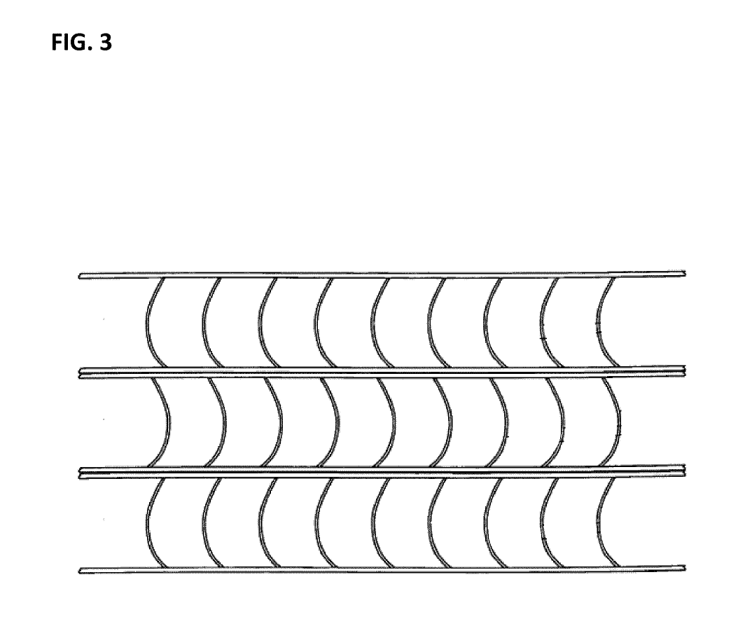

In some cases, the filament bow orientation of the layers of the spacer textile is staggered. For example, as shown in FIG. 3, the bow orientation between adjacent layers may be set so that orientation of the filaments in adjacent layers differs, e.g., by 180 degrees. Such spacer textiles will demonstrate an interface pressure reduction when compared to fabrics with a single layer or layers where the spacer fibers are oriented in the same direction. In specific embodiments of the invention, the orientation of adjacent layers may differ by any amount between 0 degrees and 180 degrees. Staggering the orientation of the layers advantageously reduces the directionality of the pressure absorbing properties of the spacer textile.

In some embodiments, the spacer fibers comprise a material selected from the group consisting of polyester or a semi-rigid polymer, e.g., urethane or nylon. In particular embodiments, the spacer fibers comprise polyester.

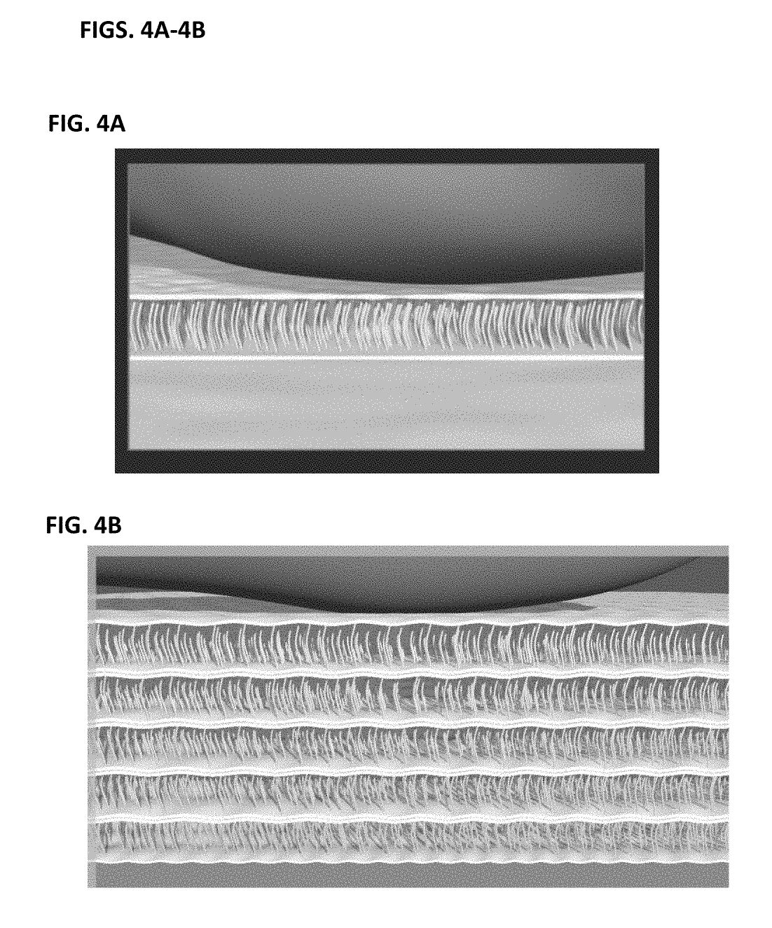

While a single layer of spacer fabric may be employed in many applications, in some embodiments of the invention, a layered spacer fabric is fabricated with two or more (e.g., 2, 3, 4, 5, 6, 7, 8, 9, 10, or more) layers of a spacer textile, as shown in FIGS. 3, 4A, and 4B. The spacer textile of FIG. 3 includes three layers, and the spacer pad shown in FIG. 4B includes five layers of a spacer textile, but any number of layers may be included. The three layers of spacer textile shown in FIG. 3 or the five layers of spacer textile shown in FIG. 4B have the advantage of functioning more smoothly and finely to resist pressure at the thickness necessary for a pressure relieving surface (generally about half an inch), when compared to a spacer textile consisting of a single layer, such as that shown in FIG. 4A. Further, a multilayer pad construction using thinner spacer textile layers offers the additional advantage of being more compatible with sewing as a fabrication technique than a pad constructed from a thicker single layer of a spacer textile.

In some cases, each of the one or more layers of spacer textile in the pad has a thickness from 2 mm to 16 mm, e.g., from 2 mm to 7 mm, from 3 mm to 8 mm, from 4 mm to 9 mm, from 10 mm to 15 mm, or from 11 mm to 16 mm, e.g., 2 mm, 3 mm, 4 mm, 5 mm, 6 mm, mm 7, 8 mm, 9 mm, 10 mm, 11 mm, 12 mm, 13 mm, 14 mm, 15 mm, or 16 mm.

The overall thickness of the one or more layers of the spacer textile of the pad may be from 3 mm to 30 mm, e.g., from 3 mm to 10 mm, from 5 mm to 15, from 10 mm to 20 mm, from 15 mm to 25 mm, or from 20 mm to 30 mm, e.g., 3 mm, 4 mm, 5 mm, 6 mm, mm 7, 8 mm, 9 mm, 10 mm, 11 mm, 12 mm, 13 mm, 14 mm, 15 mm, or 16 mm, 17 mm, 18 mm, 19 mm, 20 mm, 21 mm, 22 mm, 23 mm, 24 mm, 25 mm, 26 mm, 27 mm, 28 mm, 29 mm, or 30 mm. An exemplary pad has a thickness of 12 mm.

The characteristics of the spacer textile and the pad incorporating said spacer textile are optimized for maintaining and restoring joint function in a canine in need thereof. The relative indentation load resistance (e.g., softness) of a material can be measured, for example, by a Rex Durometer (e.g., a Rex Shore OO model 1600), an industry standard gauge that conforms to ASTM D2240. In some embodiments of the invention, the uppermost spacer layer registers an indentation load resistance from 15 to 50, e.g., from 15 to 30, from 20 to 35, from 25 to 40, or from 35 to 50, e.g., 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as measured by the Shore durometer scale OO. In particular embodiments, the pad of the present invention has an indentation load resistance of 30-40 as measured by the Shore durometer scale OO.

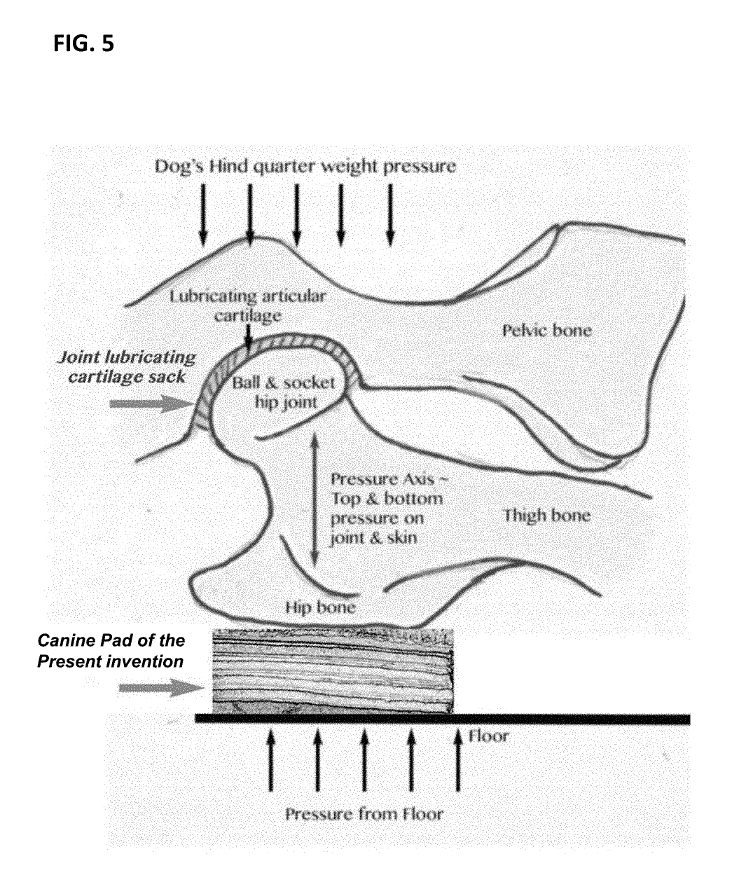

The invention described herein incorporates one or more layers of a spacer textile as described herein into a pad that is configured to be placed onto a hard surface, e.g., floor, for a canine to rest upon. The pad reduces pressure exerted on a joint, e.g., a hip or shoulder joint, when a canine lies upon the pad. In certain embodiments, the protective pad reduces pressure exerted on the hip from bone conduction from the hip bone to the femoral head. For example, as shown in FIG. 5, the pressure axis from the hip bone to the femoral head pushes up on the lubricating articular cartilage between the femoral head and the socket of the pelvic bone; concurrently, the canine's hind quarter weight exerts a force, e.g., pressure, down on the lubricating articular cartilage. If the canine is not lying on a pad to relieve the increased pressure, the cartilage becomes compressed in the joint and the fluid of said cartilage may leak, reducing the cushioning effect of the cartilage and causing discomfort, e.g., a stiff and painful hip.

In some embodiments of the invention, a comfort-enhancing material is incorporated into the top surface of the uppermost layer of the spacer textile. For example, the comfort-enhancing material may be any comfort-enhancing material known in the art, including but not limited to, faux fur, expanded urethane (e.g., polyurethane, e.g., “memory foam” or similar), polyester fill, e.g., polyfill, a closed cell foam (e.g., ethylene propylene diene monomer, e.g., neoprene), or an open cell foam (e.g., reticulated foam, polyurethane foam, or open cell rubber), or other similar materials. An exemplary comfort-enhancing material is faux fur.

In some embodiments, a slip-resistant material is incorporated into the bottom surface of the lowermost layer of the spacer textile. In certain embodiments, the slip-resistant material is waterproof. For example, the slip-resistant material may contain polyvinylchloride (PVC), urethane, or copolymers or polymer coated fabrics. For example, the slip-resistant material may be a thermoplastic polyolefin (TPO), natural rubber, or synthetic rubber.

In some embodiments, the pad is polygonal, e.g., square or rectangular, circular, or ovoid, but may be of any suitable shape. When the pad is configured to be rectangular, the length and width of the pad are, independently, between about 13 inches and about 60 inches. In some embodiments, the length and width are, independently, from about 13 inches to about 20 inches (e.g., about 13 inches, about 14 inches, about 15 inches, about 16 inches, about 17 inches, 18 inches, about 19 inches, or about 20 inches), about 21 inches to about 30 inches (e.g., about 21 inches, about 22 inches, about 23 inches, about 24 inches, about 25 inches, about 26 inches, about 27 inches, about 28 inches, about 29 inches, or about 30 inches), about 31 inches to about 40 inches (e.g., about 31 inches, about 32 inches, about 33 inches, about 34 inches, about 35 inches, about 36 inches, about 37 inches, about 38 inches, about 39 inches, or about 40 inches), about 41 inches to about 50 inches (e.g., about 41 inches, about 42 inches, about 43 inches, about 44 inches, about 45 inches, about 46 inches, about 47 inches, about 48 inches, about 49 inches, or about 50 inches), or about 51 inches to about 60 inches (e.g., about 51 inches, about 52 inches, about 53 inches, about 54 inches, about 55 inches, about 56 inches, about 57 inches, about 58 inches, about 59 inches, or about 60 inches).

In some embodiments, the length and width are, independently, from about 13 inches to 30 inches (e.g., about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, or about 30), from about 20 inches to about 40 inches (e.g., about 20 inches, about 21 inches, about 22 inches, about 23 inches, about 24 inches, about 25 inches, about 26 inches, about 27 inches, about 28 inches, about 29 inches, about 30 inches, about 31 inches, about 32 inches, about 33 inches, about 34 inches, about 35 inches, about 36 inches, about 37 inches, about 38 inches, about 39 inches, from about 40), from about 30 inches to about 50 inches (e.g., about 30 inches, about 31 inches, about 32 inches, about 33 inches, about 34 inches, about 35 inches, about 36 inches, about 37 inches, about 38 inches, about 39 inches, about 40 inches, about 41 inches, about 42 inches, about 43 inches, about 44 inches, about 45 inches, about 46 inches, about 47 inches, about 48 inches, about 49 inches, or about 50), or from about 40 inches to about 60 inches (e.g., about 40 inches, about 41 inches, about 42 inches, about 43 inches, about 44 inches, about 45 inches, about 46 inches, about 47 inches, about 48 inches, about 49 inches, about 50 inches, about 51 inches, about 52 inches, about 53 inches, about 54 inches, about 55 inches, about 56 inches, about 57 inches, about 58 inches, about 59 inches, or about 60).

### Methods of Use

Featured herein are methods for maintaining or restoring joint function in a canine in need thereof using a spacer textile-based pad as described herein. In particular, the methods include providing a pad that includes a spacer textile described herein (e.g., one or more layers of a spacer textile) and allowing the canine to lie down on the pad such that the pad contacts a joint (e.g., a hip joint), where the spacer textile of the pad conforms to the joint and provides an upward force attenuation onto the joint.

Generally, when a canine lies on a hard surface, e.g., a floor, automotive trunk, or similar location, the canine's hind quarter weight exerts a force on a joint (e.g., a hip joint). The pressure from the hard surface and the pressure from the canine's body mass combined with hip anatomy creates large pressures forces on the hip joint and its articular cartilage as shown in FIG. 5. The pressure exerted on the articular cartilage dehydrates the lubricating cartilage sack during every sleep period, increasing friction in the ball and socket joint and can weaken the hip joint over time.

Providing the canine with a pad described herein (e.g., a pad including one or more layers of a spacer textile), provides a floating suspension surface capable of reducing the pressure on the joint, thereby lessening transient articular cartilage dehydration of the canine, thus aiding in maintaining or restoring joint function in a canine in need thereof.

### EXAMPLES

### Spacer Textiles Compared to Memory Foam

Memory foam, while currently used for canine orthopedic pads and beds, has several disadvantages as an orthopedic material. First, memory foam made from expanded urethane, e.g., polyurethane, as well as other viscoelastic materials, tend to “remember” the shape of an object that is placed onto them. Once the object is removed, the foam slowly returns to its original shape. When compressed under load, memory foam and other similar materials tend to bottom out against the surface they are resting on, e.g., the hip or shoulder joint, and remain statically compressed, thus providing little upward cushioning effect to the object placed onto the surface of the material. Second, memory foam and other similar materials tend to significantly indent under load, thus necessitating the use of a greater thickness of the material in order to provide a stable platform. Given equal Shore Durometer OO values, the smaller the contact surface area of the indenting object, the greater the penetration depth into the material of the indenting object. With respect to canines, the foot bottom contact surface of a canine is a small surface area indenting object, and a canine that steps onto a 6″ thick Shore Durometer OO 10 memory foam pad with all four paws may indent the foam by 2-3 inches at each paw. This causes instability and may lead to joint dysfunction and discomfort as the canine attempts to stand and leave the pad, especially in geriatric or infirm canines.

In contrast, the use of a multilayer spacer textile pad provides a more stable platform as the spacer fibers of each spacer textile layer provide an upward force attenuation onto the joint that contacts the pad. The spacer textile pad of the invention does not have a “memory” effect, and retains its shape under compressive load from the canine, thus providing a stable platform for the canine to lie down and stand up on the pad without risk of injury or further joint damage. The spacer textile of the pad of the invention further prevents the formation of callouses and bald spots on the skin of the canine. Table 1 provides a summary of the advantages of the spacer textile-based pad of the present invention relative to currently available memory foam canine orthopedic pads.

TABLE 1
Advantages of the Spacer Textile-Based Pad of
the Present Invention Relative to Currently Available
Memory Foam Canine Orthopedic Pads

| Feature | Current Invention | Memory Foam |
|---|---|---|
| Breathable | Yes | No |
| Demonstrated Case | Yes | No |
| Study Results | | |
| Launderable | Yes | No |
| Flexible/foldable | Yes | No |
| Heat dissipation | Yes | No |
| Support mechanism | Upward force | Static compression |
| Base material | Layered spacer textile | Open cell viscoelastic |
| | | foam |
| Thickness | 12 mm | 75-200 mm |
| Stability | Stable; limited | Unstable; small surface |
| | compression | area of canine foot results |
| | | in deep indentation into |
| | | foam |
| Direct Skin | Comfort material | Woven fabric coated cover |
| Contact Surface | | |

### Other Embodiments

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure that come within known or customary practice within the art to which the disclosure pertains and may be applied to the essential features hereinbefore set forth.

Other embodiments are within the claims.

1. A method of maintaining or restoring joint function in a canine in need thereof, comprising:
a) providing a pad comprising one or more layers of a spacer textile, wherein each of the one or more layers of the spacer textile comprises a top surface, a bottom surface, and plurality of spacer fibers therebetween; and
b) allowing the canine to contact a joint on the top surface of the pad, wherein the one or more layers of the spacer textile of the pad provides an upward force attenuation onto the joint.

2. The method of claim 1, wherein each of the one or more layers of the spacer textile has a thickness from 2 to 16 mm.

3. The method of claim 1, wherein the one or more layers of the spacer textile of the pad has a thickness from 3 to 30 mm.

4. The method of claim 1, wherein the top spacer layer registers an indentation load resistance of durometer Shore OO from 15 to 50.

5. The method of claim 1, wherein the top surface or bottom surface of each of the one or more layers of the spacer textile comprises a material selected from the group consisting of polyester, elastane, rayon, acrylic copolymers, nylon, polypropylene, cotton, tricot, olefin, or a combination thereof.

6. The method of claim 5, wherein the top surface or bottom surface of each of the one or more layers of the spacer textile comprises a combination of polyester and elastane copolymer.

7. The method of claim 1, wherein the spacer fibers comprise a material selected from the group consisting of polyester or a semi-rigid polymer.

8. The method of claim 7, wherein the spacer fibers comprise polyester.

9. The method of claim 1, wherein the pad comprises five layers of the spacer textile.

10. The method of claim 9, wherein the pad has a thickness of 12 mm.

11. The method of claim 1, wherein the plurality of spacer fibers of each of the one or more layers of the spacer textile are oriented substantially in the same direction.

12. The method of claim 1, wherein the plurality of spacer fibers are each of the one or more layers of the spacer textile are oriented in a staggered configuration.

13. The method of claim 1, wherein the top surface of the uppermost layer of the spacer textile further comprises a comfort-enhancing material.

14. The method of claim 13, wherein the comfort-enhancing material comprises polyurethane, a polyfill, closed cell foam, or open cell foam.

15. The method of claim 13, wherein the comfort-enhancing material comprises faux fur.

16. The method of claim 1, wherein the bottom surface of the lowermost layer of the spacer textile further comprises a slip-resistant material.

17. The method of claim 16, wherein the slip-resistant material comprises polyvinylchloride, urethane, copolymers, polymer coated fabrics, a thermoplastic polyolefin, natural rubber, or synthetic rubber.
